(19) United States
(12) Patent Application Publication
(10) Pub. No.: US 2017/0344485 A1
(43) Pub. Date: Nov. 30, 2017

(54) HETEROGENEOUS RUNAHEAD CORE FOR DATA ANALYTICS

(71) Applicant: International Business Machines Corporation, Armonk, NY (US)

(72) Inventors: Chia-Yu Chen, White Plains, NY (US); Jungwook Choi, Elmsford, NY (US); Shu-Jen Han, Cortlandt Manor, NY (US); Yinglong Xia, Rye Brook, NY (US)

(21) Appl. No.: 15/164,551

(22) Filed: May 25, 2016

(51) Int. Cl. G06F 12/0875; G06F 9/30

(52) U.S. Cl. CPC G06F 12/0875; G06F 9/30043; G06F 2212/452

(57) ABSTRACT

Techniques that facilitate heterogeneous runahead processing for a processor core are provided. In one example, a first core performs a first execution of a first sequence of instructions, where the first core is communicatively coupled to a first cache memory. A second core performs a second execution of at least a portion of the first sequence of instructions and a first determination that data associated with the first sequence of instructions fails to be stored in the first cache memory, where the first determination is performed concurrent with the first execution, and the first core executes a second sequence of instructions based on a second determination that the second core is performing the second execution of at least a portion of the first sequence of instructions.

### BACKGROUND

The subject disclosure relates to computer architecture, and more specifically, to execution of processing threads associated with a processor core.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus and/or computer program products that facilitate heterogeneous runahead processing for a processor core are described.

According to an embodiment, a device is provided. The device can comprise a first core and a second core. The first core can perform a first execution of a first sequence of instructions and the first core can be communicatively coupled to a first cache memory. The second core can perform a second execution of at least a portion of the first sequence of instructions and a first determination that data associated with the first sequence of instructions fails to be stored in the first cache memory. The first determination can be performed concurrent with the first execution. The first core can execute a second sequence of instructions based on a second determination that the second core is performing the second execution of at least a portion of the first sequence of instructions.

According to another embodiment, a computer-implemented method is provided. The computer-implemented method can comprise determining, by a first processor core, that a sequence of instructions executed by a second processor core is associated with a cache miss. The computer-implemented method can also comprise executing, by the first processor core, at least a portion of the sequence of instructions concurrently with execution of another sequence of instructions by the second processor core. The computer-implemented method can also comprise storing, by the first processor core, memory operation data associated with the portion of the sequence of instructions in a cache memory. The computer-implemented method can also comprise executing, by the first processor core, one or more sequences of instructions prior to execution of the one or more sequences of instructions by the second processor core.

According to yet another embodiment, a computer program product for executing threads of execution can comprise a computer readable storage medium having program instructions embodied therewith. The program instructions can be executable by a main processor core and cause the main processor core to execute a first portion of a thread of execution. The program instructions can also cause the main processor core to execute a second portion of the thread of execution in response to a determination that the thread of execution is associated with a cache miss. The program instructions can also cause the main processor core to re-execute the first portion of a thread of execution in response to a determination that a runahead processor core coupled to the processor core is speculatively executing the thread of execution. The program instructions can also cause the main processor core to utilize data provided by the runahead processor core in response to a determination that the thread of execution is associated with another cache miss.

### DESCRIPTION OF THE DRAWINGS

FIG. 1 illustrates a block diagram of an example, non-limiting system that facilitates heterogeneous runahead processing for a processor core in accordance with one or more embodiments described herein.

FIG. 2 illustrates another block diagram of an example, non-limiting system that facilitates heterogeneous runahead processing for a processor core in accordance with one or more embodiments described herein.

FIG. 3 illustrates a block diagram of an example, non-limiting device that couples a main processor core and a runahead processor core using silicon in accordance with one or more embodiments described herein.

FIG. 4 illustrates a block diagram of an example, non-limiting device that couples a main processor core and a runahead processor core using via structures in accordance with one or more embodiments described herein.

FIG. 5 illustrates a block diagram of an example, non-limiting device that couples a main processor core and a runahead processor core using carbon nanotube technology in accordance with one or more embodiments described herein.

FIG. 6 illustrates an example, non-limiting timing diagram associated with a main processor core and another example, non-limiting timing diagram associated with a runahead processor core in accordance with one or more embodiments described herein.

FIG. 7 illustrates a flow diagram of an example, non-limiting computer-implemented method that facilitates heterogeneous runahead processing in accordance with one or more embodiments described herein.

FIG. 8 illustrates a flow diagram of an example, non-limiting computer-implemented method that facilitates speculative execution of a sequence of instructions in accordance with one or more embodiments described herein.

FIG. 9 illustrates a flow diagram of another example, non-limiting computer-implemented method that facilitates speculative execution of a sequence of instructions in accordance with one or more embodiments described herein.

FIG. 10 illustrates a graph showing a memory bandwidth window for a main processor core that employs a runahead processor core in accordance with one or more embodiments described herein.

FIG. 11 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

With the increase in data analytics for various network-connected applications (e.g., social network applications, big data applications, data recognition applications), processing of a vast amount of data and/or irregular patterns of data by a processor is becoming more common. However, such processing often results in an increased number of cache misses for a processor. A cache miss is a condition in which data requested for processing by a processor is not included in a cache memory for the processor. Cache misses can lead to decreased performance and/or decreased efficiency for the processor.

Embodiments described herein include systems, computer-implemented methods, apparatus and computer program product that facilitate speculative execution of data for a processor core by employing heterogeneous runahead processing. For example, in one embodiment, a runahead processor core can be employed in addition to a main processor core to process outstanding load cache misses and/or outstanding store cache misses associated with executing threads for a data algorithm. In a non-limiting example, a runahead processor core can be employed in addition to a main processor core to process load cache misses and/or store cache misses associated with executing threads for a graph data algorithm that maps data in a database to determine relationships and/or correlations between the data. The runahead processor core can perform a runahead operation (e.g., a runahead algorithm) for the main processor core by pre-processing one or more threads for the main processor core (e.g., “running ahead” of the main processor core) and/or by storing load cache misses and/or store cache misses associated with the pre-processing of the one or more threads. The runahead processor core can be a hardware accelerator for the main processor core with a computer architecture that is designed for performing a runahead operation (e.g., a runahead algorithm) for the main processor core. In an aspect, the runahead processor core can store the load cache misses and/or the store cache misses in a runahead cache memory that is different than a cache memory for the main processor core. By performing the runahead operation for the main processor core, the runahead processor core can allow the main processor core to process another thread without stalling the main processor core. Therefore, when a cache miss occurs for the main processor core, the main processor core can refer to the load cache misses and/or the store cache misses determined by the runahead processor core. Furthermore, if a memory address matches a memory address associated with the cache miss, the main processor core can employ respective data determined by the runahead processor core, thereby reducing a number of cache misses associated with the main processor core. As such, processing performance (e.g., relative efficiency, processing power, memory bandwidth, number of instructions per cycle, maximum processing cycles, processing speed, throughput, etc.) of the main processor core can be improved.

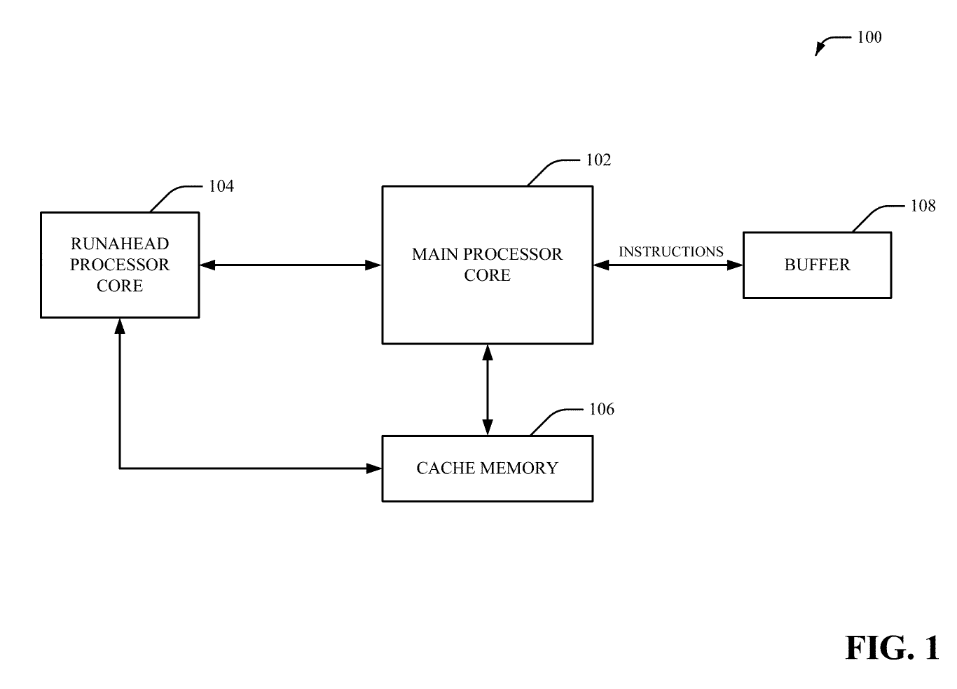

FIG. 1 illustrates a block diagram of an example, non-limiting system that facilitates heterogeneous runahead processing for a processor core in accordance with one or more embodiments described herein. For example, the heterogeneous runahead processing can involve performing runahead processing for a sequence of instructions (e.g., a thread of execution) on a runahead processor core that is distinct from a main processor core that initiated execution of the sequence of instructions. In various embodiments, the system 100 can be a multi-processor system. Moreover, the system 100 can be associated with or be included in a data analytics system, a data processing system, a graph analytics system, a graph processing system, a big data system, a social network system, a speech recognition system, an image recognition system, a graphical modeling system, a bioinformatics system, a data compression system, an artificial intelligence system, an authentication system, a syntactic pattern recognition system, a medical system, a health monitoring system, a network system, a computer network system, a communication system, a router system, a server system, a high availability server system (e.g., a Telecom server system), a Web server system, a file server system, a data server system, a disk array system, a powered insertion board system, a cloud-based system or the like.

The system 100 can be employed to use hardware and/or software to solve problems that are highly technical in nature, that are not abstract and that cannot be performed as a set of mental acts by a human. Further, some of the processes performed may be performed by a specialized computer (e.g., a runahead processor core) for carrying out defined tasks related to memory operations. The system 100 and/or components of the system can be employed to solve new problems that arise through advancements in technology, computer networks, the Internet and the like. The system 100 can provide technical improvements to processor systems and/or memory systems by improving processing efficiency of a main processor core, reducing delay in processing performed by a main processor core, avoiding or reducing the likelihood of a main processor core entering a stalled state, increasing an instruction window size for a main processing core, reducing number of cache misses associated with a main processor core, maximizing memory bandwidth for a main processor core, and/or increasing a number of instruction per cycle for a main processor core, etc.

In the embodiment shown in FIG. 1, the system 100 can include a main processor core 102, a runahead processor core 104, a cache memory 106 and a buffer 108. As shown in FIG. 1, the main processor core 102 can be communicatively coupled to the runahead processor core 104. In an aspect, the runahead processor core 104 can be or include a hardware accelerator for the main processor core 102 that provides improved processing performance for the main processor core 102. For example, processing performance and/or processing efficiency of the main processor core 102 can be improved employing one or more of the embodiments described herein in connection with the runahead processor core 104. In some embodiments, the main processor core 102 can be communicatively coupled to the cache memory 106. Furthermore, in certain implementations, the runahead processor core 104 can be communicatively coupled to the cache memory 106.

In one example, the cache memory 106 can be implemented as a primary cache (e.g., a Level-1 cache, a first level data cache) that is implemented on the main processor core 102 and/or the main processor core 102 can access the cache memory 106 with a minimal amount of time delay with respect to other cache memories associated with the main processor core 104. In another example, the cache memory 106 can be implemented as a secondary cache (e.g., a Level-2 cache or a Level-3 cache) that is implemented separate from the main processor core 102 and/or the main processor core 102 can access another cache memory (not shown) with a lower amount of time delay than the cache memory 106. However, it is to be appreciated that the cache memory 106 can be implemented as a different type of cache memory. Moreover, in an implementation, the cache memory 106 can include more than one level of cache where a first portion of the cache memory 106 is implemented on the main processor core 102 and a second portion of the cache memory 106 is implemented separate from the main processor core 102. The main processor core 102 and the runahead processor core 104 can be communicatively coupled to the cache memory 106 via a shared memory bus. For example, in certain implementations, the main processor core 102 and the runahead processor core 104 can access the cache memory 106 and/or received data from the cache memory 106 via a corresponding communication bus.

Instructions (e.g., INSTRUCTIONS shown in FIG. 1) stored in the buffer 108 can be received and processed by the main processor core 102. For example, the main processor core 102 can execute an instruction pipeline associated with one or more instructions (e.g., INSTRUCTIONS shown in FIG. 1) that are received from the buffer 108. The buffer 108 can be an instruction buffer that stores the one or more instructions in a queue for the main processor core 102. The buffer 108 can store instructions until a sequence of instructions is executed by the main processor core 102. For example, a particular instruction can be deleted from the buffer 108 in response to the particular instruction being transmitted to the main processor core 102. The instructions associated with the buffer 108 can be instructions for one or more threads of execution. Moreover, the one or more instructions stored in the buffer 108 can be associated with data analytic data generated and/or provided by a data analytics system, graph data generated and/or provided by a graph analytics system, social network data generated and/or provided by a social network system, speech data generated and/or provided by a speech recognition system, image data generated and/or provided by an image recognition system, graphical model data generated and/or provided by a graphical modeling system, bioinformatics data generated and/or provided by a bioinformatics system, compressed data generated and/or provided by a data compression system, learned data generated and/or provided by an artificial intelligence system, authentication data generated and/or provided by an authentication system, pattern recognition data generated and/or provided by a syntactic pattern recognition system, medical data generated and/or provided by a medical system, monitoring data generated and/or provided by a health monitoring system, network data generated and/or provided by a network system, etc. In a non-limiting example, the one or more instructions stored the buffer 108 can be related to a data analytics process and/or a graph analytics process. Furthermore, the instructions associated with the buffer 108 can be processor instructions (e.g., load instructions and/or store instructions). The main processor core 102 can be, for example, an out-of-order processor core that performs out-of-order execution of the instructions stored in the buffer 108. For example, the main processor core 102 can execute the instructions associated with the buffer 108 in a different order than the instructions are stored in the buffer 108. The main processor core 102 can also be, for example, a central processing unit. In one example, the buffer 108 can be a reorder buffer that comprises an out-of-order sequence of instructions to be executed by the main processor core 102. Furthermore, the runahead processor core 104 can be an in-order processor core that performs in-order execution of instructions. For example, the runahead processor core 104 can execute instructions in an order that the instructions are received by the runahead processor core 104.

The runahead processor core 104 can speculatively execute a sequence of instructions in response to detection of a cache miss at the cache memory 106 during execution of the sequence of instructions by the main processor core 102. A cache miss can be a condition in which data requested by the main processor core 102 during execution of the sequence of instructions by the main processor core 102 fails to be stored in the cache memory 106. Speculative execution by the runahead processor core 104 can be a technique in which the runahead processor core 104 executes one or more computing tasks for the main processor core 102 and stores data associated with the computing tasks so that the data can be potentially utilized by the main processor core 102 at a future instance in time. For instance, with respect to speculative execution, runahead processor core 104 can perform a runahead process with respect to the main processor core 102 to facilitate pre-processing of one or more other sequences of instructions for the main processor core 102 and/or collection of outstanding load misses and/or store misses for the main processor core 102. A load miss can be a condition in which data requested by the main processor core 102 during execution of a sequence of load instructions by the main processor core 102 fails to be stored in the cache memory 106. A store miss can be a condition in which data requested by the main processor core 102 during execution of a sequence of store instructions by the main processor core 102 fails to be stored in the cache memory 106. The runahead processor core 104 can predict data that can be utilized by the main processor core 102 at a later instance of time by executing a sequence of instructions for the main processor core 102 before the main processor core 102 finishes executing the sequence of instructions (e.g., the runahead processor core 104 can execute at least a portion of a main thread of execution before a corresponding portion of the main thread of execution is executed by the main processor core 102). Furthermore, when data requested by the main processor core 102, in response to execution of a sequence of instructions, fails to be stored the cache memory 106, the main processor core 102 can utilize the predicted data generated by the runahead processor core 104 to execute sequence of instructions and/or one or more other sequences of instructions.

The main processor core 102 can be a first hardware processor core (e.g., a first processing unit) and the runahead processor core 104 can be a second hardware processor core (e.g., a second processing unit). The runahead processor core 104 can be coupled to and/or deposited on the main processor core 102 using a silicon layer of the main processor core 102, carbon nanotube technology and/or one or more through-silicon vias. Moreover, the runahead processor core 104 can comprise a different computer architecture than the main processor core 102. For example, the runahead processor core 104 can be a smaller computer chip than the main processor core 102 that utilizes less processing power and/or less hardware than the main processor core 102, the runahead processor core 104 can comprise a computer architecture that is simpler than a computer architecture of the main processor core 102, the runahead processor core 104 can utilize a lower amount of power than the main processor core 102, and/or the runahead processor core 104 can execute data at a faster rate than the main processor core 102. In various embodiments, the main processor core 102 and/or the runahead processor core 104 can be a combination of hardware and software that performs a computing task (e.g., execution of a sequence of instructions). For example, the main processor core 102 can comprise a combination of hardware and software to execute at least a sequence of instructions associated with a set of computing tasks for a data analytics system, a data processing system, a graph analytics system, a graph processing system, a big data system, a social network system, a speech recognition system, an image recognition system, a graphical modeling system, a bioinformatics system, a data compression system, an artificial intelligence system, an authentication system, a syntactic pattern recognition system, a medical system, a health monitoring system, a network system, a computer network system and/or a communication system. Furthermore, the runahead processor core 104 can comprise a combination of hardware and software to execute at least a runahead algorithm associated with the sequence of instructions associated with the set of computing tasks. The main processor core 102 and/or the runahead processor core 104 can execute a sequence of instructions (e.g., a thread of execution) that cannot be performed by a human (e.g., is greater than the capability of a single human mind). For example, an amount of data processed, a speed of processing of data and/or data types processed by the main processor core 102 and/or the runahead processor core 104 over a certain period of time can be greater, faster and different than an amount, speed and data type that can be processed by a single human mind over the same period of time. Furthermore, data processed by the main processor core 102 and/or the runahead processor core 104 can be encoded data (e.g., a sequence of binary bits) and/or compressed data. The main processor core 102 and/or the runahead processor core 104 can also be fully operational towards performing one or more other functions (e.g., fully powered on, fully executed, etc.) while also processing the above-referenced sequence of instructions and/or data.

In an aspect, the main processor core 102 can perform a first execution of a first sequence of instructions (e.g., a first thread of execution) associated with instructions received by the buffer 108. In response to a determination by the runahead processor core 104 that data associated with the first sequence of instructions fails to be stored in the cache memory 106 (e.g., a cache miss associated with the cache memory 106 occurs), the runahead processor core 104 can perform a second execution of at least a portion of the first sequence of instructions. For example, the runahead processor core 104 can continue processing a portion of the first sequence of instructions that is not executed by the main processor core 102 in response to a determination by the runahead processor core 104 that data associated with the first sequence of instructions fails to be stored in the cache memory 106. The data associated with the first sequence of instructions that fails to be stored in the cache memory 106 can be data needed by the main processor core 102 to adequately execute the first sequence of instructions. In another example, the runahead processor core 104 can re-execute at least a portion of the first sequence of instructions that is previously executed by the main processor core 102 in response to a determination by the runahead processor core 104 that data associated with the first sequence of instructions fails to be stored in the cache memory 106. In yet another example, the runahead processor core 104 can continue processing a portion of the first sequence of instructions that is pre-processed by the main processor core 102 in response to a determination by the runahead processor core 104 that data associated with the first sequence of instructions fails to be stored in the cache memory 106. The data that fails to be stored in the cache memory 106 can be data (e.g., a data value, a cache memory location, etc.) requested for processing by the main processor core 102 with respect to the first sequence of instructions.

The runahead processor core 104 and the main processor core 102 can perform operations concurrently or in parallel in some embodiments. For example, the runahead processor core 104 can determine that the data associated with the first sequence of instructions is not stored in the cache memory 106 and the main processor core 102 can perform first execution of the first sequence of instructions. The runahead processor core 104 can determine, in parallel to the first execution of the first sequence of instructions by the main processor core 102, that the data associated with the first sequence of instructions is not stored in the cache memory 106. For example, the determination by the runahead processor core 104 that the data associated with the first sequence of instructions is not stored in the cache memory 106 can be concurrent with the first execution of the first sequence of instructions by the main processor core 102. The runahead processor core 104 can determine that the data associated with the first sequence of instructions is not stored in the cache memory 106 by monitoring statuses associated with the main processor core 102. For example, the runahead processor core 104 can monitor a set of status fields that provide statuses for corresponding sequences of instructions executed by the main processor core 102. In a non-limiting example, a status field for the first execution of the first sequence of instructions can be modified, for example, in response to a determination that data associated with the first sequence of instructions is not stored in the cache memory 106. Additionally or alternatively, the main processor core 102 can communicate a status of the first execution of the first sequence of instructions to the runahead processor core 104. For example, the runahead processor core 104 can determine that the data associated with the first sequence of instructions is not stored in the cache memory 106 based on a message received from the main processor core 102. The main processor core 102 can determine that the data associated with the first sequence of instructions is not stored in the cache memory 106. The main processor core 102 can also send a signal to the runahead processor core 104 that informs the runahead processor to begin executing at least a portion of the first sequence of instructions and/or one or more other sequences of instructions. In certain implementations, at least a portion of the first sequence of instructions can be included in the signal and/or the main processor core 102 can transmit at least a portion of the first sequence of instructions to the runahead processor core 104. Alternatively, an identifier for the first sequence of instructions can be included in the signal so the runahead processor core 104 can fetch at least a portion of the first sequence of instructions from the buffer 108. The main processor core 102 can send the signal to the runahead processor core 104 via one more wired communication protocols and/or one or more wireless communication protocols.

In an embodiment, the runahead processor core 104 can synchronize communication with the main processor core 102 via a threads synchronous policy. The main processor core 102 and/or the runahead processor core 104 can maintain a buffer memory and/or a memory queue to store one or more sequences of instructions associated with cache miss. For example, a particular sequence of instructions that is not executed by the main processor core 102 (e.g., due to data associated with the particular sequence of instructions not being stored in the cache memory 106), the particular sequence of instructions can be stored in a buffer memory and/or a memory queue maintained by the main processor core 102 and/or the runahead processor core 104. As such, the runahead processor core 104 can reference the buffer memory and/or the memory queue to determine a next sequence of instructions to execute.

Additionally, the main processor core 102 can execute a second sequence of instructions in response to a determination by the main processor core 102 that the runahead processor core 104 is performing the second execution of at least a portion of the first sequence of instructions. For example, rather than stalling and/or waiting for the runahead processor core 104 to complete the second execution of the first sequence of instructions, the main processor core 102 can continue processing one or more other sequences of instructions. The one or more sequences of instructions can be next sequences of instructions stored in the buffer 108, for example. Additionally or alternatively, the one or more sequences of instructions can be a subset of the first sequence of instructions. The main processor core 102 can execute the second sequence of instructions during a runahead process associated with the runahead processor core 104. The runahead process can be a process in which the runahead processor core 104 can execute a sequence of instructions at a faster rate than the main processor core 102 and/or can determine data associated with the sequence of instructions that can be potentially utilized by the main processor core 102 during future processing of a sequence of instructions.

The main processor core 102 and the runahead processor core 104 can execute a corresponding sequence of instructions and/or different sequences of instructions during a corresponding interval of time. In response to the main processor core 102 executing the second sequence of instructions and/or one or more other sequences of instructions, the runahead processor core 104 can also speculatively execute at least a portion of the first sequence of instructions and/or one or more additional sequence of instructions. For instance, data generated in response to execution of at least a portion of the first sequence of instructions and/or one or more additional sequence of instructions by the runahead processor core 104 may or may not be employed by the main processor core 102 at a future moment in time. Furthermore, while the main processor core 102 is executing the second sequence of instructions, the runahead processor core 104 can continue executing one or more sequences of instructions at a faster rate than the main processor core 102. For example, the runahead processor core 104 can execute the second sequence of instructions subsequent to execution of the first sequence of instructions. The runahead processor core 104 can finish executing the second sequence of instructions and/or one or more other sequences of instructions before the main processor core 102 finishes executing the second sequence of instructions. As such, memory operational data (e.g., instruction miss data, load instruction miss data, store instructions miss data, instruction pre-fetch data, etc.) generated in response to execution of the second sequence of instructions and/or the one or more other sequences of instructions can be employed by the main processor core 102 at later instance in time.

In an embodiment, the runahead processor core 104 can store data (e.g., data generated in response to execution of at least a portion of the first sequence of instructions and/or one or more additional sequence of instructions by the runahead processor core 104) into the cache memory 106. Data generated in response to execution of at least a portion of the first sequence of instructions and/or one or more additional sequence of instructions can include, for example, memory operation data. In one example, data associated with the runahead processor core 104 can be stored with other data associated with the main processor core 102. In another example, a portion of the cache memory 106 can be partitioned for the main processor core 102 and another portion of the cache memory 106 can be partitioned for the runahead processor core 104. For example, a first portion of the cache memory 106 can be allocated to the main processor core 102 and a second portion of the cache memory can be allocated to the runahead processor core 104. In an aspect, subsequent to execution of the second sequence of instructions by the main processor core 102, the main processor core 102 can re-execute the first sequence of instructions associated with a cache miss. For example, in response to a determination by the main processor core 102 that the runahead processor core 104 is finished processing the first sequence of instructions and/or that the runahead processor core 104 has stored data (e.g., memory operation data) associated with the first sequence of instructions, the main processor core 102 can re-execute the first sequence of instructions. Moreover, the main processor core 102 can utilize data (e.g., memory operation data) stored in the cache memory 106 by the runahead processor core 104 in response to other cache misses associated with processing of one or more sequences of instructions by the main processor core 102. For example, in response to a determination by the main processor core 102 that data associated with a sequence of instructions fails to be stored in the cache memory 106 (e.g., a cache miss associated with the cache memory 106 occurs), the main processor core 102 can fetch data (e.g., memory operation data) stored in the cache memory 106 by the runahead processor core 104. Therefore, the data (e.g., the memory operation data) stored in the cache memory 106 by the runahead processor core 104 can be utilized by the main processor core 102 to re-execute the sequence of instructions rather than stopping execution of the sequence of instructions in response to the determination that that the data associated with the sequence of instructions fails to be stored in the cache memory 106. The runahead processor core 104 can transmit a signal to the main processor core 102 in response to a determination that execution of a sequence of instructions by the runahead processor core 104 is completed. For example, the runahead processor core 104 can inform the main processor core 102 when data (e.g., memory operation data) is available for use by the main processor core 102.

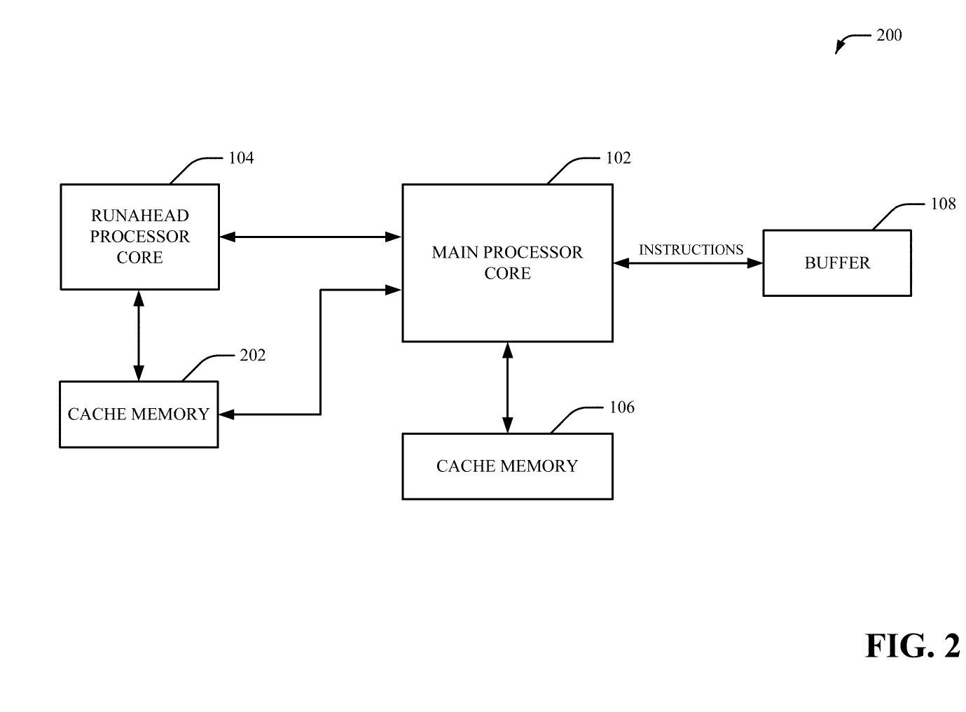

FIG. 2 illustrates another block diagram of an example, non-limiting system 200 that facilitates heterogeneous runahead processing for a processor core in accordance with one or more embodiments described herein. In various embodiments, the system 200 can be a multi-processor system and/or a multi-memory system. Repetitive description of like elements employed in other embodiments described herein is omitted for sake of brevity.

In the embodiment shown in FIG. 2, the system 200 can include the main processor core 102, the runahead processor core 104, the cache memory 106, the buffer 108 and a cache memory 202. The cache memory 202 can be communicatively coupled to the runahead processor core 104. Furthermore, in certain implementations, the cache memory 202 can also be communicatively coupled to the main processor core 102. The cache memory 202 can be a runahead cache memory that is employed exclusively to store data generated by the runahead processor core 104. In an embodiment, the cache memory 202 can be implemented separate from the runahead processor core 104. In another embodiment, the runahead processor core 104 can include the cache memory 202. For example, the cache memory 202 can be implemented on the runahead processor core 104. The main processor core 102 and the runahead processor core 104 can be communicatively coupled to the cache memory 202 via a shared memory bus.

The runahead processor core 104 can store data (e.g., data generated in response to execution of at least a portion of the first sequence of instructions and/or one or more additional sequence of instructions by the runahead processor core 104) into the cache memory 202. For example, the runahead processor core 104 can store memory operation data (e.g., instruction miss data, load instruction miss data, store instructions miss data, instruction pre-fetch data, etc.) into the cache memory 202. The data (e.g., the memory operation data) stored in the cache memory 202 can be speculatively generated for the main processor core 102. For instance, the data (e.g., the memory operation data) stored in the cache memory 202 can be generated prior to the main processor core 102 needing the data to execute one or more sequences of instructions. In an aspect, in response to a determination by the main processor core 102 that data associated with a sequence of instructions fails to be stored in the cache memory 106 (e.g., a cache miss associated with the cache memory 106 occurs), the main processor core 102 can employ the cache memory 202 to fetch data (e.g., memory operation data) associated with the sequence of instructions. For example, the main processor core 102 can reference the cache memory 202 and/or utilize data stored in the cache memory 202 (e.g., access the cache memory 202) in response to a determination that a cache miss is associated with the cache memory 106. In response to a determination by the main processor core 102 that data for the main processor core 102 is not stored in the cache memory 202 (e.g., after a determination that the data is not stored in the cache memory 106), the main processor core 102 can send a signal to the runahead processor core 104 to inform the runahead processor core 104 to execute a particular sequence of instructions associated with the data. The main processor core 102 can also continue to process other sequence of instructions until the data is stored in the cache memory 202 and/or is available for use by the main processor core 102.

In another aspect, a portion of the data (e.g., the memory operation data) stored in the cache memory 202 can be employed by the main processor core 102 and at least another portion of the data (e.g., the memory operation data) can be stored in the cache memory 202 without being utilized by the main processor core 102. For instance, the cache memory 202 can store more data (e.g., more memory operation data) than is needed by the main processor core 102. In yet another aspect, data (e.g. memory operation data) stored in the cache memory 202 can be deleted in response to a determination that a criterion associated with the main processor core 102 is satisfied. For example, data can be deleted from the cache memory 202 in response to a determination that the data is fetched by the main processor core 102. In another example, data can be deleted from the cache memory 202 in response to a determination that the data is not needed by the main processor core 102 (e.g., the data is stored in the cache memory 202 for a particular amount of time, the main processor core 102 is processing a new sequence of instructions that is not associated with the data, etc.). In yet another aspect, the runahead processor core 104 can transmit a signal to the main processor core 102 in response to a determination that data (e.g., memory operation data) is stored in the cache memory 202. For example, the runahead processor core 104 can inform the main processor core 102 when data (e.g., memory operation data) in the cache memory 202 is available for use by the main processor core 102. Alternatively, the main processor core 102 can monitor the cache memory 202 and/or can fetch data from the cache memory 202 at defined instances of time (e.g., defined intervals of time).

In a non-limiting example, the main processor core 102 can begin processing a portion of a sequence of instructions associated with graph processing data. The graph processing data can be indicative of information associated with a graph processing algorithm that maps the graph processing data in a database to determine relationships between the graph processing data. The graph processing algorithm can map graph processing data using vertices and edges that identify and/or form correlations among the graph processing data. For example, the graph processing data can encode a dataset for a graph as a set of vertices and/or a set of edges. An edge can represent a data element, and vertices can represent connections between edges (e.g., between data elements). In a non-limiting example, edges can correspond to friends for a user identity of a social network application, and vertices can correspond to connections between the friends. Therefore, the graph processing data can be associated with a vast amount of data and/or irregular patterns of correlations. Moreover, cache misses associated with processing the graph processing data can occur at a greater frequency than other types of processing. In response to a determination that a cache miss is associated with the portion of a sequence of instructions associated with graph processing data (e.g., that data for the sequence of instructions associated with graph processing data is not stored in the cache memory 106), the runahead processor core 104 can begin a runahead process associated with the sequence of instructions associated with graph processing data. For example, the runahead processor core 104 can begin processing the sequence of instructions associated with graph processing data at a faster rate than the main processor core 102 during the runahead process. Furthermore, the runahead processor core 104 can store memory operation data regarding the sequence of instructions associated with graph processing data into the cache memory 106 or the cache memory 202 for future use by the main processor core 102. Therefore, when a next cache miss occurs for the main processor core 102 during processing of the sequence of instructions associated with the graph processing data, the main processor core 102 can fetch the memory operation data associated with the runahead processor core 104 from the cache memory 106 or the cache memory 202. As such, a number of cache misses associated with processing the graph processing data by the main processor core 102 can be reduced. Furthermore, processing performance and/or processing efficiency associated with processing the graph processing data by the main processor core 102 can be improved.

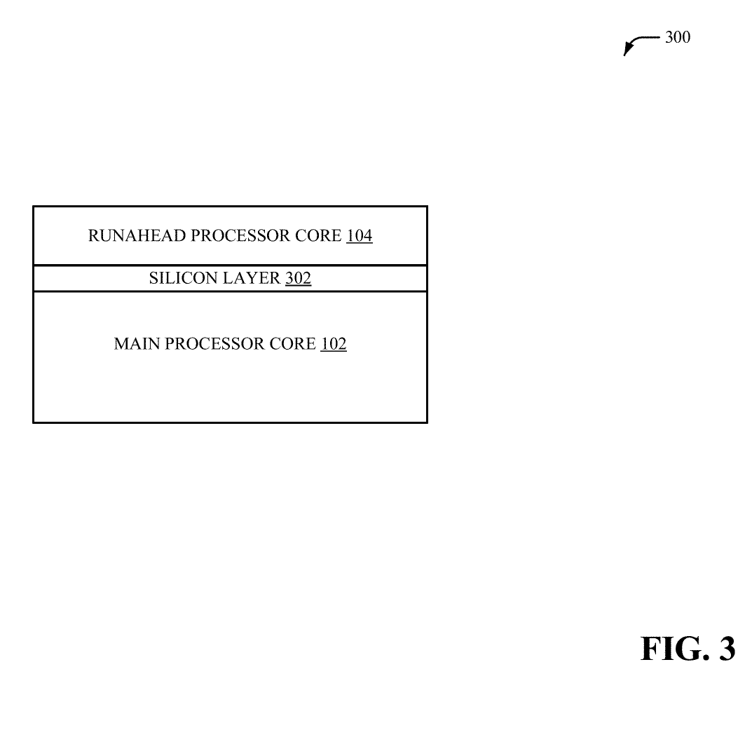

FIG. 3 illustrates a block diagram of an example, non-limiting device 300 that couples a main processor core and a runahead processor core using silicon in accordance with one or more embodiments described herein. The device 300 can include the main processor core 102 and the runahead processor core 104. Repetitive description of like elements employed in other embodiments described herein is omitted for sake of brevity.

In the embodiment shown in FIG. 3, the runahead processor core 104 can be electrically coupled to the main processor core 102 via a silicon layer 302 of the main processor core 102 that comprises silicon. For example, the runahead processor core 104 can be deposited and/or soldered to the silicon layer 302 of the main processor core 102. In one example, the runahead processor core 104 can be deposited and/or soldered to the silicon layer 302 of the main processor core 102 via solder bumps (e.g., solder micro bumps) and/or bonding pads. As such, the runahead processor core 104 can be tightly coupled to the main processor core 102, communication distance between the runahead processor core 104 and the main processor core 102 can be minimized and/or coordination of data transmissions with respect to a sequence of instructions can be realized by employing silicon to couple the runahead processor core 104 to the main processor core 102. Moreover, the silicon layer 302 can provide a thin silicon packaging solution for the main processor core 102 and the runahead processor core 104. In an embodiment, the main processor core 102 and the runahead processor core 104 can be packaged as a single chip. Furthermore, the main processor core 102 and the runahead processor core 104 can employ a shared memory bus to access the cache memory 106 and/or the cache memory 202. In an embodiment, the runahead processor core 104 can be a carbon nanotube processing core deposited on the silicon layer 302 of the main processor core 102. For example, the runahead processor core 104 can comprise one or more carbon nanotube transistors and/or one or more carbon nanotube interconnections to facilitate execution of a sequence of instructions (e.g. a thread of execution). In another embodiment, the runahead processor core 104 implemented next to the main processor core 102. For example, the runahead processor core 104 can be electrically coupled to the silicon layer 302 of the main processor core 102 via a wired connection.

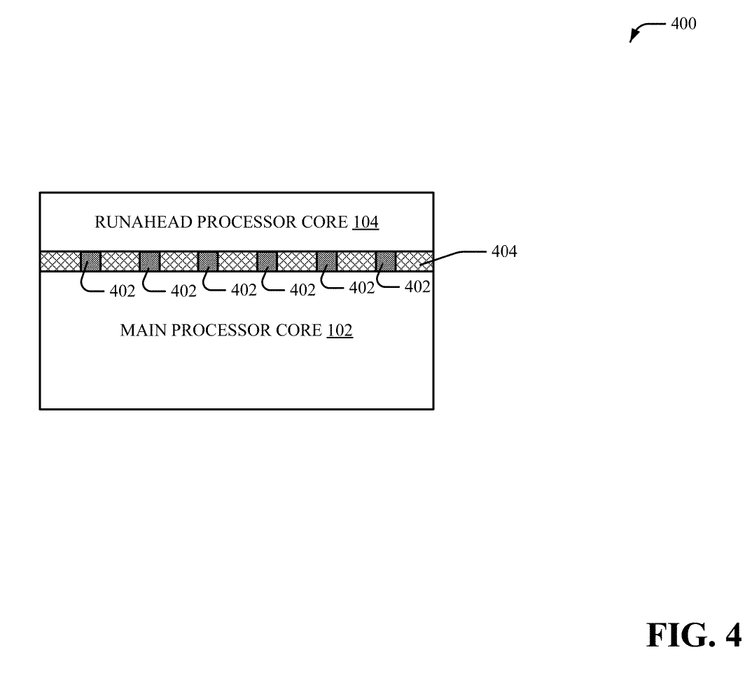

FIG. 4 illustrates a block diagram of an example, non-limiting device 400 that couples a main processor core and a runahead processor core using via structures in accordance with one or more embodiments described herein. The device 400 can include the main processor core 102 and the runahead processor core 104. Repetitive description of like elements employed in other embodiments described herein is omitted for sake of brevity.

In the embodiment shown in FIG. 4, the main processor core 102 can be a first hardware processor core and the runahead processor core 104 can be a second hardware processor core. The runahead processor core 104 can be coupled to the main processor core 102 through a set of via structures 402 to facilitate an electrical connection between the main processor core 102 and the runahead processor core 104. For example, the set of via structures 402 can be a set of through-silicon vias that pass through a silicon layer 404 that comprises silicon. The set of via structures 402 can allow the main processor core 102 and the runahead processor core 104 to be implemented as a three-dimensional (3D) stacked solution such as, for example, a 3D integrated circuit or a stacked 3D computer chip in which the runahead processor core 104 is stacked on top of the main processor core 102. As such, the runahead processor core 104 can be tightly coupled to the main processor core 102 by employing via structures to facilitate improved coordination of data transmissions with respect to a sequence of instructions, etc.

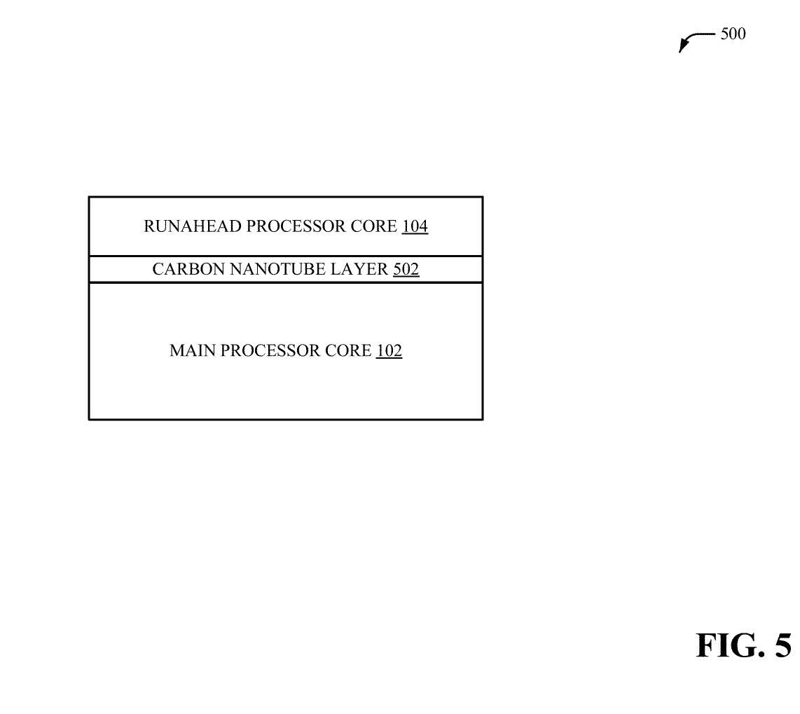

FIG. 5 illustrates a block diagram of an example, non-limiting device 500 that couples a main processor core and a runahead processor core using carbon nanotube technology in accordance with one or more embodiments described herein. The device 500 can include the main processor core 102 and the runahead processor core 104. Repetitive description of like elements employed in other embodiments described herein is omitted for sake of brevity.

In the embodiment shown in FIG. 5, the main processor core 102 can be a first hardware processor core and the runahead processor core 104 can be a second hardware processor core. The runahead processor core 104 can be coupled to the main processor core 102 through a carbon nanotube layer 502 to facilitate an electrical connection between the main processor core 102 and the runahead processor core 104. For example, the carbon nanotube layer 502 can comprise a network of carbon nanotubes (e.g., a set of carbon nanotubes, a set of carbon nanotube connections) with a cylindrical nanostructure to facilitate an electrical connection between the main processor core 102 and the runahead processor core 104. The carbon nanotube layer 502 can allow the main processor core 102 and the runahead processor core 104 to be implemented as a 3D stacked solution such as, for example, a 3D carbon nanotube computer chip in which the runahead processor core 104 is stacked on top of the main processor core 102 via the carbon nanotube layer 502. As such, the runahead processor core 104 can be tightly coupled to the main processor core 102 by employing carbon nanotube technology to facilitate improved coordination of data transmissions with respect to a sequence of instructions, etc.

In the embodiments shown in FIGS. 3, 4 and 5, the main processor core 102 can be a first hardware processor core and the runahead processor core 104 can be a second hardware processor core. The runahead processor core 104 can be special-purpose hardware for the main processor core 102 to enhance processing performance of the main processor core 102. For example, the runahead processor core 104 can be a customized hardware accelerator for runahead processing (e.g., the runahead processor core 104 can be a specialized hardware component for runahead processing). Furthermore, the main processor core 102 and the runahead processor core 104 can be implemented on a single computer chip. The runahead processor core 104 can comprise a smaller size than the main processor core 102, the runahead processor core 104 can comprise a computer architecture that is simpler than a computer architecture of the main processor core 102, the runahead processor core 104 can utilize a lower amount of power than the main processor core 102, and/or the runahead processor core 104 can execute a sequence of instructions at a faster rate than the main processor core 102. Moreover, combining the runahead processor core 104 with the main processor core 102, as shown in embodiments associated with FIGS. 1, 2, 3, 4 and 5, is non-obvious since the runahead processor core 104 is a novel processor core for performing runahead operations and the combination of the runahead processor core 104 and the main processor core 102 allows improved processing performance and/or processing efficiency of the main processor core 102.

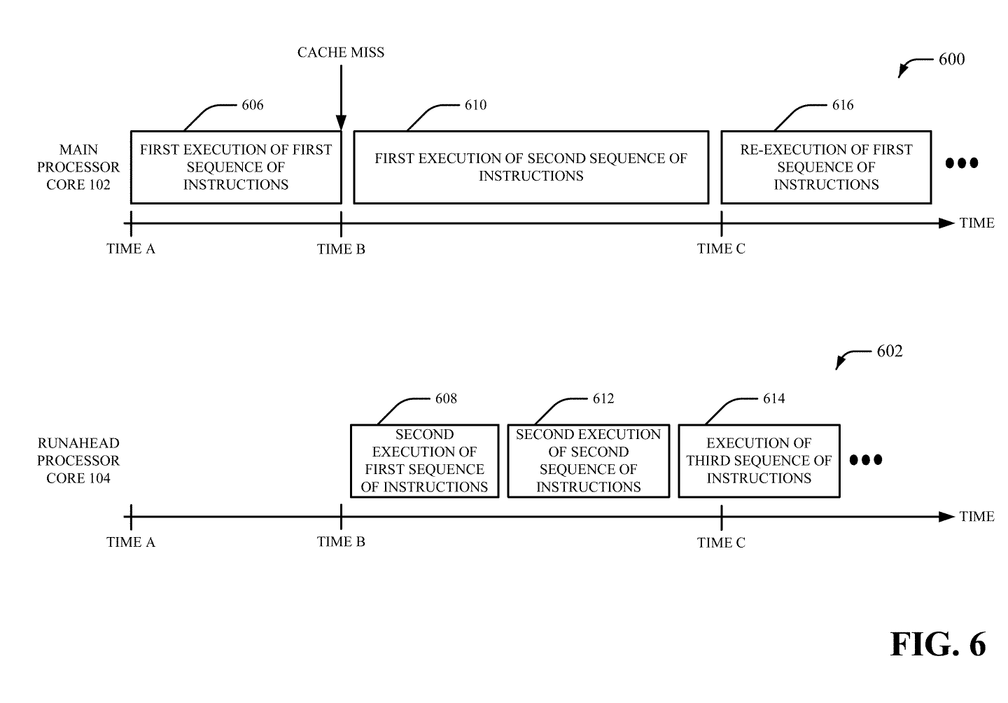

FIG. 6 illustrates an example, non-limiting timing diagram 600 associated with a main processor core and timing diagram 602 associated with a runahead processor core in accordance with one or more embodiments described herein. Repetitive description of like elements employed in other embodiments described herein is omitted for sake of brevity.

The timing diagram 600 can be associated with the main processor core 102 and the timing diagram 602 can be associated with the runahead processor core 104. The timing diagram 600 and the timing diagram 602 can be associated with a corresponding time interval with respect to computing tasks. A computing task can be one or more sequence of instructions (e.g., one or more threads of execution for execution by a processor core). In the non-limiting example shown in FIG. 6, the main processor core 102 can begin a computing task 606 at time A. The computing task 606 performed by the main processor core 102 can be a first execution of a first sequence of instructions. The first sequence of instructions can be received, for example, from the buffer 108. At time B, the main processor core 102 and/or the runahead processor core 104 can determine that a cache miss associated with the cache memory 106 has occurred. For example, at time B, the main processor core 102 and/or the runahead processor core 104 can determine that data associated with the computing task 606 (e.g., the first sequence of instructions) fails to be stored in the cache memory 106. In response to the determination that data associated with the computing task 606 (e.g., the first sequence of instructions) fails to be stored in the cache memory 106, the runahead processor core 104 can begin a computing task 608. The computing task 608 performed by the runahead processor core 104 can be a second execution of the first sequence of instructions. Additionally, in response to the determination that data associated with the computing task 606 (e.g., the first sequence of instructions) fails to be stored in the cache memory 106, the main processor core 102 can begin a computing task 610. The computing task 610 performed by the main processor core 102 can be a first execution of a second sequence of instructions. The second sequence of instructions can be received, for example, from the buffer 108.

The computing task 608 performed by the runahead processor core 104 (e.g., the second execution of the first sequence of instructions) can be associated with a runahead process in which the runahead processor core 104 can pre-process at least a portion of the first sequence of instructions and/or one or more other sequences of instructions for the main processor core 102. For example, the runahead processor core 104 can speculatively execute at least a portion of the first sequence of instructions via the computing task 608. Additionally, while the main processor core 102 performs the computing task 610 (e.g., the first execution of the second sequence of instructions), the runahead processor core 104 can perform (e.g., speculatively execute) a computing task 612 and/or a computing task 614. The computing task 612 performed by the runahead processor core 104 can be a second execution of the second sequence of instructions. The computing task 614 performed by the runahead processor core 104 can be an execution of a third sequence of instructions. The third sequence of instructions can be received, for example, from the buffer 108.

The runahead processor core 104 can perform the computing task 608, the computing task 612 and/or the computing task 614 at a faster rate than the main processor core 102. For example, the runahead processor core 104 can execute the second execution the first sequence of instructions, the second execution of the second sequence of instructions and/or the execution of the third sequence of instructions at a faster rate than the main processor core 102. The runahead processor core 104 can also store data associated with the computing task 608, the computing task 612 and/or the computing task 614. For instance, the runahead processor core 104 can store memory operation data (e.g., instruction misses, load misses, store misses, instruction pre-fetch data, etc.) associated with the second execution the first sequence of instructions, the second execution of the second sequence of instructions and/or the execution of the third sequence of instructions at a faster rate than the main processor core 102. In one embodiment, the data (e.g., the memory operation data) can be stored in the cache memory 106. In another embodiment, the data (e.g., the memory operation data) can be stored in the cache memory 202. The data (e.g., the memory operation data) generated by the runahead processor core 104 can be potentially utilized by the main processor core 102. For example, in response to a cache miss associated with the cache memory 106 while performing the computing task 610 (e.g., while executing the first execution of the second sequence of instructions), the main processor core 102 can utilize the data (e.g., the memory operation data) generated by the runahead processor core 104 that is stored in the cache memory 106 or in the cache memory 202.

The main processor core 102 can utilize the data (e.g., the memory operation data) generated by the runahead processor core 104 that is stored in the cache memory 106 or in the cache memory 202 since the runahead processor core 104 finishes the computing task 612 (e.g., the second execution of the second sequence of instructions) before the main processor core 102 finishes the computing task 610 (e.g., the first execution of the second sequence of instructions) at time C. After time C, the main processor core 102 can perform a computing task 616. The computing task 616 performed by the main processor core 102 can be a re-execution of the first sequence of instructions. In an aspect, after the runahead processor core 104 finishes the computing task 608, the computing task 612 and/or the computing task 614, the runahead processor core 104 can send a message to the main processor core 102 to inform the main processor core 102 that data (e.g., the memory operation data) associated with the computing task 608, the computing task 612 and/or the computing task 614 is available for use. Therefore, the main processor core 102 can determine which sequence of instructions to execute based on feedback data provided by the runahead processor core 104. In response to a cache miss associated with the cache memory 106 while performing the computing task 616 (e.g., while re-executing the first sequence of instructions), the main processor core 102 can utilize the data (e.g., the memory operation data) generated by the runahead processor core 104 that is stored in the cache memory 106 or in the cache memory 202. After performing the computing task 614, the runahead processor core 104 can, for example, continue to execute one or more other sequences of instructions to predict data (e.g., memory operation data) for the main processor core 102. Furthermore, after performing the computing task 616, the main processor core 102 can, for example, continue to execute the third sequence of instructions, etc.

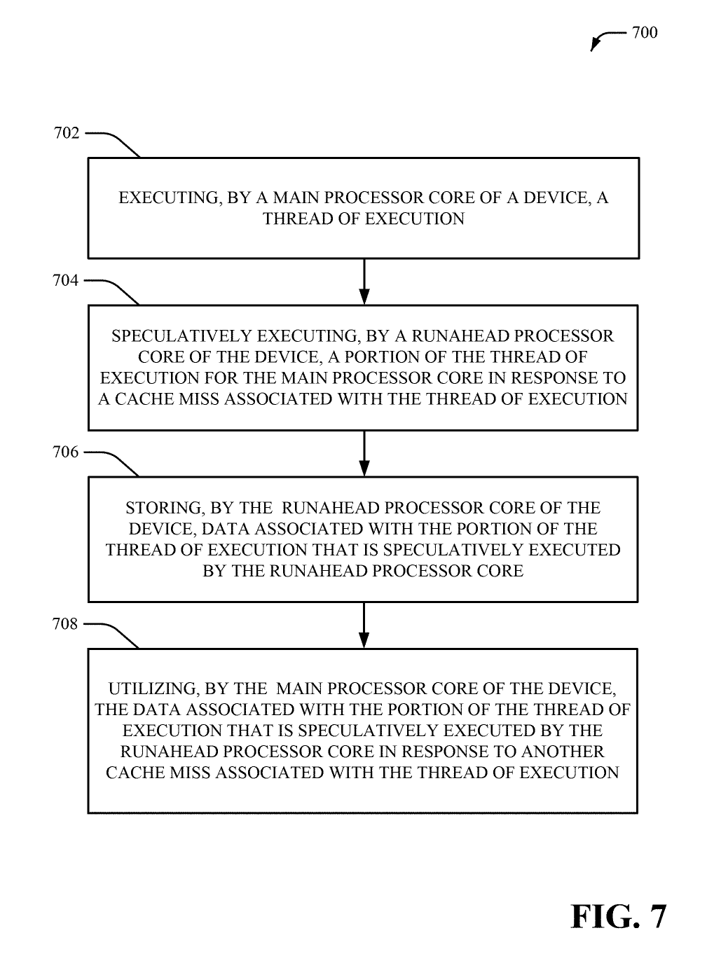

FIG. 7 illustrates a flow diagram of an example, non-limiting computer-implemented method 700 that facilitates heterogeneous runahead processing in accordance with one or more embodiments described herein. At 702, a thread of execution is executed by a main processor core (e.g., by main processor core 102 of a device). For example, a main processor core can receive a processing thread (e.g., a main processing thread, a sequence of instructions, etc.) from a buffer (e.g., the buffer 108) and/or can begin executing the processing thread. In an aspect, a cache memory (e.g., the cache memory 106) can be searched for data associated with the thread of execution and/or data associated with the thread of execution can be obtained from (e.g., fetched from) a cache memory (e.g., the cache memory 106). In one example, the main processor core can be an out-of-order processor and/or a central processing unit.

At 704, a portion of the thread of execution for the main processor core is speculatively executed by a runahead processor core (e.g., by runahead processor core 104 of the device) in response to a cache miss associated with the thread of execution. For example, portion of the thread of execution for the main processor core can be speculatively executed by a runahead processor core in response to a determination that data associated with the thread of execution fails to be stored in a cache memory (e.g., the cache memory 106) associated with the main processor core. While the runahead processor core is speculatively executing the portion of the thread of execution, the main processor core can continue executing portion(s) of the thread of execution. The runahead processor core can process and/or execute the portion of the thread of execution at a faster rate than the execution of the thread of execution by the main processor core. For instance, the runahead processor core can complete processing and/or executing the portion of the thread of execution before the main processor core. In an aspect, the runahead processor core can comprise a smaller size than the main processor core, the runahead processor core can comprise a computer architecture (e.g., a hardware and/or software architecture) that is simpler than a computer architecture (e.g., a hardware and/or software architecture) of the main processor core, and/or the runahead processor core can utilize a lower amount of power (e.g., a lower level of voltage and/or current) than the main processor core. Furthermore, the runahead processor core can be coupled to and/or deposited on the main processor core using a silicon layer of the main processor core, carbon nanotube technology, a set of through-silicon vias, and/or a 3D stacking technique.

At 706, data associated with the portion of the thread of execution that is speculatively executed by the runahead processor core is stored by the runahead processor core (e.g., by runahead processor core 104 of the device). For example, memory operation data (e.g., instruction misses, load instruction misses, store instructions misses, instruction pre-fetch data, etc.) can be stored by the runahead processor core for future use by the main processor core. In an embodiment, the data associated with the portion of the thread of execution that is speculatively executed by the runahead processor core can be stored in a cache memory (e.g., the cache memory 106) associated with the cache miss. In another embodiment, the data associated with the portion of the thread of execution that is speculatively executed by the runahead processor core can be stored in a runahead cache memory (e.g., the cache memory 202) that is formatted exclusively for the data associated with the portion of the thread of execution that is speculatively executed by the runahead processor core. In an aspect, the runahead processor core can store more data (e.g., more memory operation data) than what is needed by the main processor core. For example, only a portion of the data associated with the portion of the thread of execution that is speculatively executed by the runahead processor core can be employed by the main processor core at a future instance in time.

At 708, the data associated with the portion of the thread of execution that is speculatively executed by the runahead processor core is utilized by the main processor core (e.g., by main processor core 102 of the device) in response to another cache miss associated with the thread of execution. For example, since the main processor core can continue executing portion(s) of the thread of execution while the runahead processor core is speculatively executing the portion of the thread of execution and/or storing the data associated with the portion of the thread of execution that is speculatively executed by the runahead processor core, the main processor core can fetch the data associated with the runahead processor core in response to another cache miss associated with the portion(s) of the thread of execution. The main processor core can fetch the data associated with the portion of the thread of execution that is speculatively executed by the runahead processor core from another partition of a cache memory (e.g., the cache memory 106) that is associated with the other cache miss. Alternatively, the main processor core can fetch the data associated with the portion of the thread of execution that is speculatively executed by the runahead processor core from a different cache memory (e.g., the cache memory 202) that is not associated with the other cache miss. Accordingly, a number of cache misses associated with the main processor core can be reduced, processing performance of the main processor core can be improved, processing efficiency of the main processor core can be improved, delay sin processing of the thread of execution by the main processor core can be reduced, likelihood of the main processor core entering a stalled state can be reduced, an instruction window size for the main processing core can be increase, a number of instructions per miss for the main processor core can be increase, memory bandwidth for the main processor core can be increased, and/or a number of instruction per cycle for the main processor core can be increased.

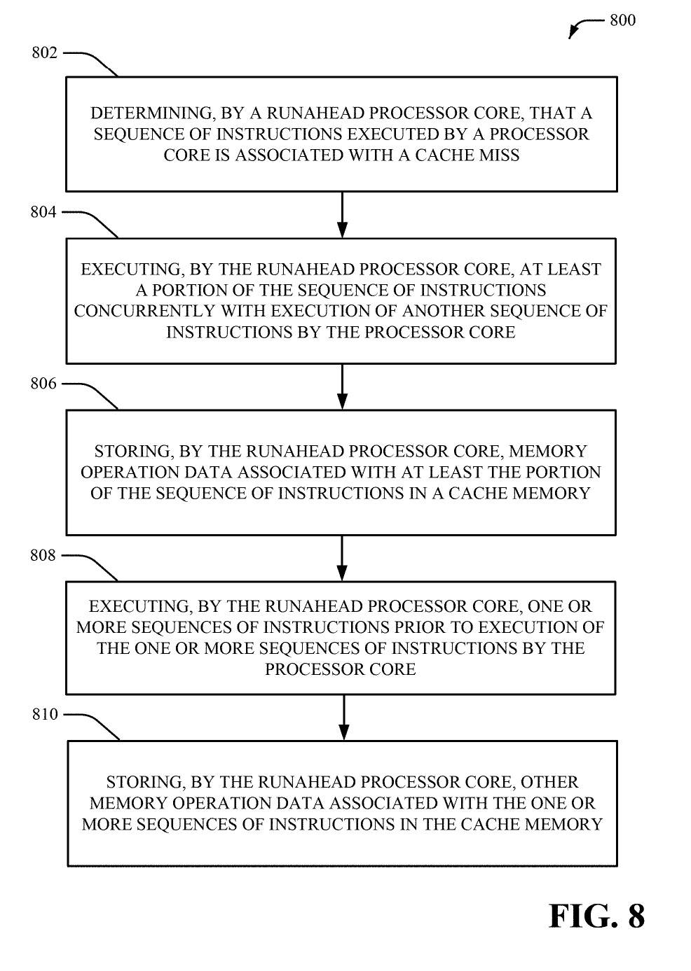

FIG. 8 illustrates a flow diagram of an example, non-limiting computer-implemented method 800 that facilitates speculative execution of a sequence of instructions in accordance with one or more embodiments described herein. At 802, it is determined, by a runahead processor core (e.g., by runahead processor core 104), that a sequence of instructions executed by a processor core is associated with a cache miss. For example, it can be determined that data associated with the sequence of instructions that is executed by the processor core (e.g., the main processor core 102) fails to be stored in a cache memory (e.g., the cache memory 106). In an aspect, a signal (e.g., a message) from the processor core can be received that indicates that the sequence of instructions is associated with the cache miss. The signal (e.g., the message) from the processor core can also provide information regarding with the sequence of instructions that is associated with the cache miss and/or other information for processing the sequence of instructions. Additionally or alternatively, the processor core can be monitored for a cache miss.

At 804, at least a portion of the sequence of instructions is executed, by the runahead processor core (e.g., by runahead processor core 104), concurrently with execution of another sequence of instructions by the processor core. For example, while the portion of the sequence of instructions is executed, the processor core can execute another sequence of instructions in parallel (e.g., the processor core can continue processing other sequence of instructions). The portion of the sequence of instructions can be executed at a first rate and the other sequence of instructions associated with the processor core can be executed at a second rate, wherein the first rate is greater than the second rate. As such, processing of the portion of the sequence of instructions can be finished before processing of the other sequence of instructions by the processor core. At least a portion of the other sequence of instructions executed by the processor core can correspond to the portion of the sequence of instructions that is executed in response to the cache miss. Moreover, the sequence of instructions that is executed concurrently with execution of the other sequence of instructions by the processor core can be a speculative execution of the sequence of instructions.

At 806, memory operation data associated with at least the portion of the sequence of instructions is stored, by the runahead processor core (e.g., by runahead processor core 104), in a cache memory. For example, instruction miss data associated with the portion of the sequence of instructions, load instruction miss data associated with the portion of the sequence of instructions, store instructions miss data associated with the portion of the sequence of instructions, instruction pre-fetch data associated with the portion of the sequence of instructions and/or other data associated with the portion of the sequence of instructions can be stored in a cache memory. The cache memory that stores the memory operation data can be a cache memory (e.g., the cache memory 106) that is associated with the cache miss. For example, the memory operation data can be stored in one or more partitions of the cache memory that is different than partition(s) associated with the cache miss and/or the sequence of instructions executed by the processor core. Alternatively, the memory operation data can be stored in a cache memory (e.g., the cache memory 202) that is different than a cache memory associated with cache miss.

At 808, one or more sequences of instructions is executed, by the runahead processor core (e.g., by runahead processor core 104), prior to execution of the one or more sequences of instructions by the processor core. For example, processing of one or more sequences of instructions associated with the other sequence of instructions by the processor core can be completed prior to the processor core. The one or more sequences of instructions can be executed at a faster rate and/or can be initiated prior to execution by the processor core.

At 810, other memory operation data associated with the one or more sequences of instructions is stored (e.g., by runahead processor core 104) in the cache memory. For example, instruction miss data associated with the one or more sequences of instructions, load instruction miss data associated with the one or more sequences of instructions, store instructions miss data associated with the one or more sequences of instructions, instruction pre-fetch data associated with the one or more sequences of instructions and/or other data associated with the one or more sequences of instructions can be stored in a cache memory.

The cache memory that stores the other memory operation data can be a cache memory (e.g., the cache memory 106) that is associated with the cache miss. For example, the other memory operation data can be stored in one or more partitions of the cache memory that is different than partition(s) associated with the cache miss and/or the sequence of instructions executed by the processor core. Alternatively, the other memory operation data can be stored in a cache memory (e.g., the cache memory 202) that is different than a cache memory associated with cache miss. In an aspect, the other memory operation data associated with the one or more sequences of instructions can be stored in the data cache before the processor core executes the one or more sequences of instructions. In another aspect, the other memory operation data can be employed by the processor core in response to a cache miss associated with a future execution of a sequence of instruction by the processor core. In yet another aspect, a signal can be transmitted to the processor core in response to execution of the one or more sequences of instructions and/or a determination that the other memory operation data associated with the one or more sequences of instructions is stored in the cache memory.

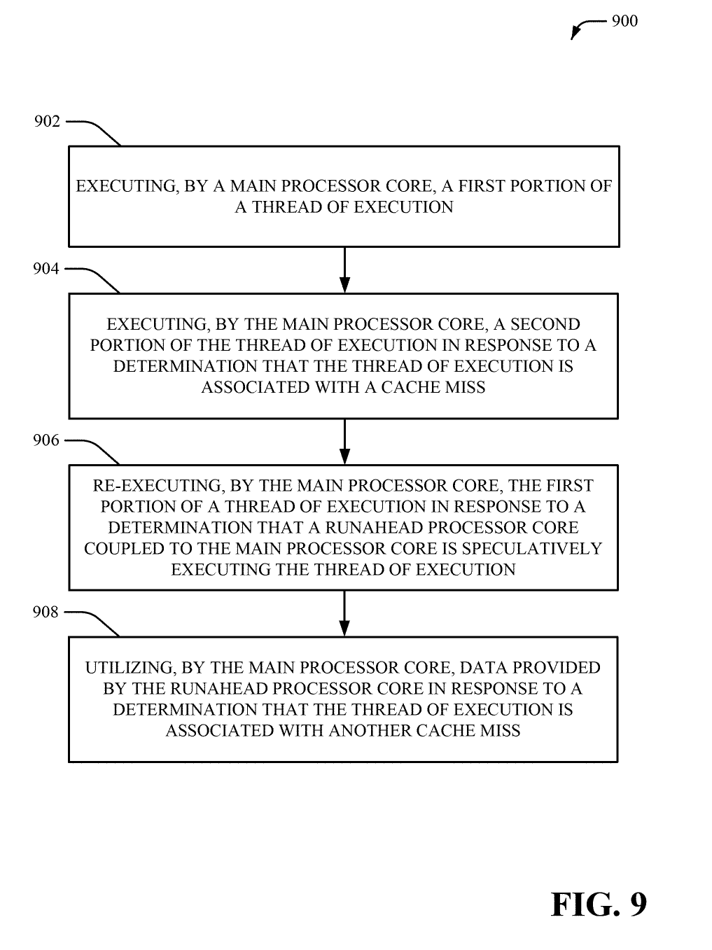

FIG. 9 illustrates another flow diagram of an example, non-limiting computer-implemented method 900 that facilitates speculative execution of a sequence of instructions in accordance with one or more embodiments described herein. At 902, a first portion of a thread of execution is executed, by a main processor core (e.g., by main processor core 102). For example, a first portion of a thread of execution that is received from a buffer (e.g., the buffer 108) can be executed. The first portion of the thread of execution can include one or more sequences of instructions. Furthermore, execution of the first portion of the thread of execution can include fetching data associated with the first portion of the thread of execution from a cache memory (e.g., the cache memory 106).

At 904, a second portion of the thread of execution is executed, by the main processor core (e.g., by main processor core 102), in response to a determination that the thread of execution is associated with a cache miss. For example, the second portion of the thread of execution can be executed in response to a determination that data associated with the thread of execution is not stored in a cache memory (e.g., the cache memory 106). In an aspect, processing of a sequence of instructions associated with the thread of execution can be stopped and processing of another sequence of instructions associated with the thread of execution can be initiated in response to a determination that the thread of execution is associated with a cache miss. Therefore, processing of the thread of execution is not stalled in response to a determination that the thread of execution is associated with a cache miss.

At 906, the first portion of a thread of execution is re-executed, by the main processor core (e.g., by main processor core 102), in response to a determination that a runahead processor core coupled to the main processor core is speculatively executing the thread of execution. For example, the first portion of a thread of execution can be re-executed in response to a determination that data (e.g., memory operation data) associated with the cache miss is generated by the runahead processor core.

At 908, data provided by the runahead processor core is utilized, by the main processor core (e.g., by main processor core 102), in response to a determination that the thread of execution is associated with another cache miss. For example, memory operation data can be fetched from a cache memory (e.g., the cache memory 202) in response to a determination that the thread of execution is associated with another cache miss. Therefore, a number of cache misses can be reduced since the data is speculatively executed and/or stored by the runahead processor core.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

Moreover, because configuration of sequence of instructions (e.g., threads of execution) and/or communication between a main processor core and a runahead processor core is established from a combination of electrical and mechanical components and circuitry, a human is unable to replicate or perform the subject data packet configuration and/or the subject communication between processing components and/or an assignment component. For example, a human is unable to decode and/or process an encoded sequence of instructions (e.g., an encoded thread of execution) associated with a sequence of bits. Furthermore, a human is unable to communicate data and/or packetized data for communication between a main processor core (e.g., a first hardware processor core) and a runahead processor core (e.g., a second hardware processor core).

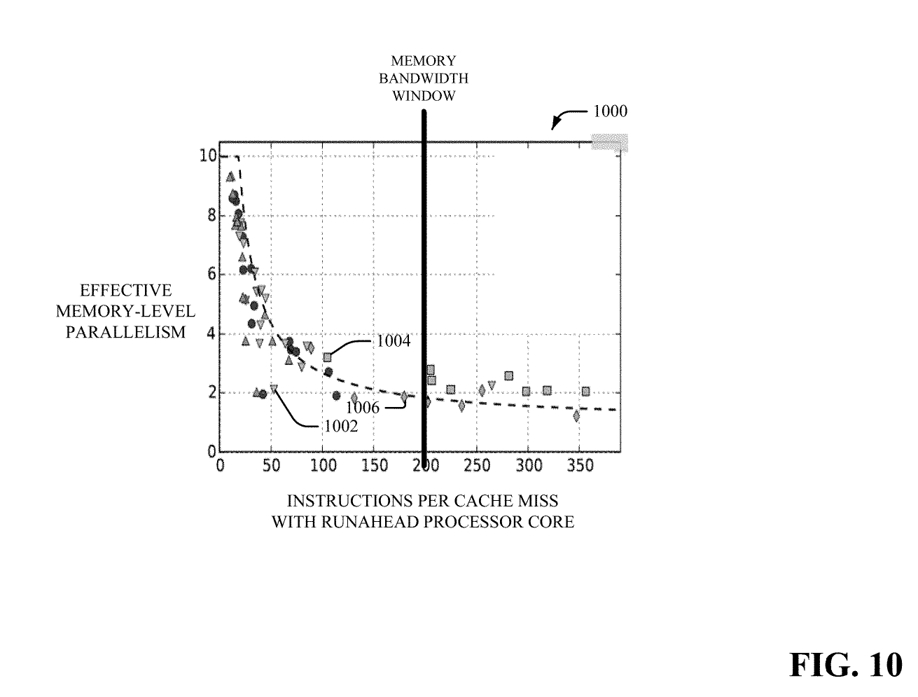

FIG. 10 illustrates a graph 1000 associated with a memory bandwidth window for a main processor core (e.g., the main processor core 102) that employs a runahead processor core (e.g., the runahead processor core 104) in a processor system and/or a memory system (e.g., the system 100 or the system 200) in accordance with one or more embodiments described herein. An x-axis of the graph 1000 depicts a total number of instructions per cache miss. For example, a total number of instructions per cache miss can be a total number of processing instructions (e.g. sequence of instructions) executed by a main processor core (e.g., the main processor core 102) before a cache miss occurs with respect to the main processor core (e.g., the main processor core 102). A y-axis of the graph 1000 depicts effective memory-level parallelism. For example, effective memory-level parallelism can be a weighted value on a scale from 1 to 10 indicative of effectiveness of a main processor core (e.g., the main processor core 102) to handle multiple memory operations within a certain period of time. As seen in FIG. 10, a memory bandwidth window for a main processor core (e.g., the main processor core 102) can be maximized if a runahead processor core (e.g., runahead processor core 104) is employed with the main processor core (e.g., the main processor core 102). For example, with a runahead processor core (e.g., runahead processor core 104) to speculatively execute one or more sequences of instructions for a main processor core (e.g., the main processor core 102), a memory bandwidth window for a main processor core (e.g., the main processor core 102) can store an increased number of processing instructions, such as processing instruction 1002 that is associated with approximately 50 instructions per cache miss and an effective memory-level parallelism value equal to approximately 2, processing instruction 1004 that is associated with approximately 100 instructions per cache miss and an effective memory-level parallelism value equal to approximately 3.5, processing instruction 1006 that is associated with approximately 175 instructions per cache miss and an effective memory-level parallelism value equal to approximately 2, etc. Moreover, if a runahead processor core (e.g., runahead processor core 104) is employed with the main processor core (e.g., the main processor core 102), a number of processing instructions for the main processor core (e.g., the main processor core 102) that occurs outside the memory bandwidth window can be minimized Therefore, performance and/or efficiency of a main processor core (e.g., main processor core 102) can be increased by employing a runahead processor core (e.g., runahead processor core 104) with the main processor core (e g, main processor core 102), as more fully disclosed herein.

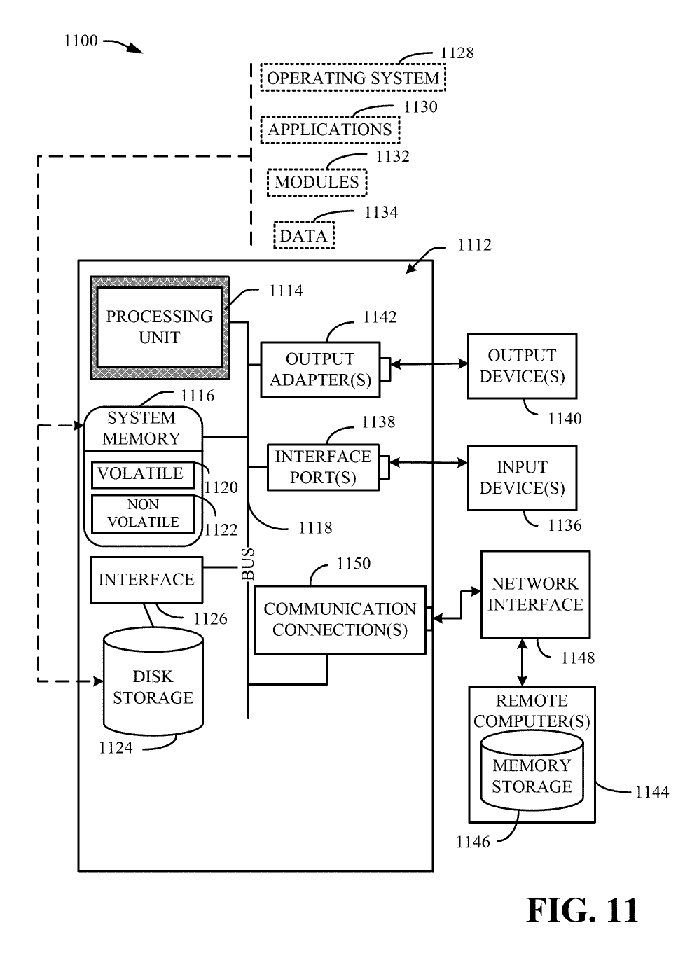

In order to provide a context for the various aspects of the disclosed subject matter, FIG. 11 as well as the following discussion are intended to provide a general description of a suitable environment in which the various aspects of the disclosed subject matter can be implemented. FIG. 11 illustrates a block diagram of an example, non-limiting operating environment in which one or more embodiments described herein can be facilitated. Repetitive description of like elements employed in other embodiments described herein is omitted for sake of brevity. With reference to FIG. 11, a suitable operating environment 1100 for implementing various aspects of this disclosure can also include a computer 1112. The computer 1112 can also include a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114. The system bus 1118 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1116 can also include volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1120 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1112 can also include removable/non-removable, volatile/non-volatile computer storage media. FIG. 11 illustrates, for example, a disk storage 1124. Disk storage 1124 can also include, but is not limited to, devices like a magnetic disk drive, floppy disk drive, tape drive, Jaz drive, Zip drive, LS-100 drive, flash memory card, or memory stick. The disk storage 1124 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1124 to the system bus 1118, a removable or non-removable interface is typically used, such as interface 1126. FIG. 11 also depicts software that acts as an intermediary between users and the basic computer resources described in the suitable operating environment 1100. Such software can also include, for example, an operating system 1128. Operating system 1128, which can be stored on disk storage 1124, acts to control and allocate resources of the computer 1112.

System applications 1130 take advantage of the management of resources by operating system 1128 through program modules 1132 and program data 1134, e.g., stored either in system memory 1116 or on disk storage 1124. It is to be appreciated that this disclosure can be implemented with various operating systems or combinations of operating systems. A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port can be used to provide input to computer 1112, and to output information from computer 1112 to an output device 1140. Output adapter 1142 is provided to illustrate that there are some output devices 1140 like monitors, speakers, and printers, among other output devices 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a computer, a server, a router, a network PC, a workstation, a microprocessor based appliance, a peer device or other common network node and the like, and typically can also include many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1150 refers to the hardware/software employed to connect the network interface 1148 to the system bus 1118. While communication connection 1150 is shown for illustrative clarity inside computer 1112, it can also be external to computer 1112. The hardware/software for connection to the network interface 1148 can also include, for exemplary purposes only, internal and external technologies such as, modems including regular telephone grade modems, cable modems and DSL modems, ISDN adapters, and Ethernet cards.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device, comprising:
a first core that performs a first execution of a first sequence of instructions, wherein the first core is communicatively coupled to a first cache memory; and
a second core that performs a second execution of at least a portion of the first sequence of instructions and a first determination that data associated with the first sequence of instructions fails to be stored in the first cache memory, wherein the first determination is performed concurrent with the first execution, and wherein the first core executes a second sequence of instructions based on a second determination that the second core is performing the second execution of at least a portion of the first sequence of instructions.

2. The device of claim 1, wherein the second core is coupled to the first core employing through-silicon vias.

3. The device of claim 1, further comprising one or more carbon nanotubes that couple the second core to the first core.

4. The device of claim 1, wherein the second core is coupled to a silicon layer of the first core.

5. The device of claim 1, wherein the first core executes the second sequence of instructions during a runahead process associated with the second execution of at least a portion of the first sequence of instructions.

6. The device of claim 1, wherein the second core executes the second sequence of instructions subsequent to execution of at least a portion of the first sequence of instructions.

7. The device of claim 1, wherein the first core re-executes the first sequence of instructions subsequent to execution of the second sequence of instructions.

8. The device of claim 1, wherein the second core stores memory operation data associated with the first sequence of instructions in a second cache memory communicatively coupled to the second core and based on the second execution of at least a portion of the first sequence of instructions.

9. The device of claim 8, wherein the data is first data, and wherein the first core accesses the second cache memory in response to a third determination that second data associated with the second sequence of instructions fails to be stored in the first cache memory.

10. The device of claim 1, wherein the first core is an out-of-order processor that processes sequences of instructions at a first rate and the second core is a runahead processor that processes sequences of instructions at a second rate, and wherein the second rate is greater than the first rate.

11. The device of claim 1, wherein the second core comprises a carbon nanotube processing device formed on a silicon layer associated with the first core.

12. The device of claim 1, wherein the first cache memory comprises a first level data cache implemented on the first core, and wherein the second core performs the second execution of at least a portion of the first sequence of instructions based on the first determination that the data associated with the first sequence of instructions fails to be stored in the first level data cache.

13. The device of claim 1, wherein the first sequence of instructions is associated with graph processing data indicative of information associated with a graph processing algorithm that maps the graph processing data in a database to determine relationships between the graph processing data, and wherein the first core performs the first execution of the first sequence of instructions associated with the graph processing data.

14. A computer-implemented method, comprising:
determining, by a first processor core, that a sequence of instructions executed by a second processor core is associated with a cache miss;
executing, by the first processor core, at least a portion of the sequence of instructions concurrently with execution of another sequence of instructions by the second processor core;
storing, by the first processor core, memory operation data associated with the portion of the sequence of instructions in a cache memory; and
executing, by the first processor core, one or more sequences of instructions prior to execution of the one or more sequences of instructions by the second processor core.

15. The computer-implemented method of claim 14, further comprising:
transmitting, by the first processor core, a signal to the second processor core, wherein the transmitting is performed in response to a determination that the executing the at least a portion of the sequence of instructions is complete.

16. The computer-implemented method of claim 14, further comprising:
storing, by the first processor core, other memory operation data associated with the one or more sequences of instructions in the cache memory prior to completion of the one or more sequences of instructions by the second processor core.

17. The computer-implemented method of claim 14, further comprising:
executing, by the first processor core, the one or more sequences of instructions at a faster rate than the second processor core.

18. The computer-implemented method of claim 14, wherein the executing the one or more sequences of instructions prior to the execution of the one or more sequences of instructions by the second processor core comprises increasing a memory bandwidth for the second processor core.

19. A computer program product for executing threads of execution, the computer program product comprising a computer readable storage medium having program instructions embodied therewith, the program instructions executable by a main processor core to cause the main processor core to:
execute a first portion of a thread of execution;
execute a second portion of the thread of execution in response to a determination that the thread of execution is associated with a cache miss;
re-execute the first portion of a thread of execution in response to a determination that a runahead processor core coupled to the main processor core is speculatively executing the thread of execution; and
utilize data provided by the runahead processor core in response to a determination that the thread of execution is associated with another cache miss.

20. The computer program product of claim 19, wherein the program instructions are further executable by the main processor core to cause the main processor core to:
fetch the data from a cache memory associated with the runahead processor core.
